(19) United States
(12) Patent Application Publication
(10) Pub. No.: US 2006/0036202 A1
(43) Pub. Date: Feb. 16, 2006

(54) Massage machine

(76) Inventors: Yoshiyuki Iwata, Kanagawa (JP); Hironori Ogawa, Kanagawa (JP)

Correspondence Address: FRISHAUF, HOLTZ, GOODMAN & CHICK, PC, 220 Fifth Avenue, 16TH Floor, NEW YORK, NY, 10001-7708, US

(21) Appl. No.: 10/513,973

(22) PCT Filed: Feb. 26, 2004
(86) PCT No.: PCT/JP04/02271

§ 371 Date: Nov. 9, 2004

(30) Foreign Application Priority Data
Feb. 27, 2003 (JP) 2003051672
Apr. 18, 2003 (JP) 2003114157

(51) Int. Cl. A61H 9/00

(52) U.S. Cl. 601/88; 601/86; 601/148; 601/150

(57) ABSTRACT

A massager including a shoulder massaging apparatus having a pair of massaging members and a first moving device for moving the pair of massaging members between a contacting position in which the pair of members contact with shoulders of a user and a retreated position in which the pair of massaging members are separated from the shoulders to massage the shoulders by disposing the pair of massaging members in the contacting position, a neck massaging apparatus having a second moving device for moving the pair of massaging members between a contacting position in which the pair of members contact with a neck of the user, and a retreated position in which the pair of massaging members are separated from the neck, to massage the neck by disposing the pair of massaging members in the contacting position, and a controlling apparatus for controlling operations of the shoulder and neck massaging apparatuses, the controlling apparatus being controllable independent, before and after, and simultaneous operations of the shoulder and neck massaging apparatuses, respectively.

### TECHNICAL FIELD

The present invention relates to a massager capable of efficiently massaging someone's shoulders, and someone's neck and shoulders.

### BACKGROUND ART

This kind of massager is adapted to massage user's shoulders and neck and so on by pressing a pair of right and left massaging balls or massaging members against the shoulders and the neck by use of inflation of an airbag, as shown in Japanese Patent Laid-Open 0.2002-28208.

However, only a massage operation for holding merely the neck by the right and left massaging balls or for pressing merely specific parts of the shoulders by the right and left massaging balls has been performed in the conventional massager as described above. Therefore, a massage for a basic portion of the neck by the massaging balls cannot be executed in a similar manner as a finger pressure operation performed by a person. Moreover, the pair of right and left balls are movable rightward and leftward to contact with and separate from portions of the neck, but cannot be moved to contact with and separate from the shoulders.

### DISCLOSURE OF THE INVENTION

It is, therefore, an object of the present invention to provide a massager capable of massaging a basic portion of the neck and portions of the shoulders of a user in a similar manner as a finger pressure operation performed by a person by structuring so as to be capable of massaging the shoulders efficiently without moving the user's body and the portions of the neck and the shoulders separately and simultaneously.

To achieve the above object, a massager in an aspect of the present invention comprises a shoulder massaging apparatus including a pair of massaging members and a moving device for moving the pair of members forwardly and backwardly of a user between a contacting position in which the pair of members contact with shoulders of the user and a retreated position in which the pair of massaging members are separated from the shoulders.

The shoulder massaging apparatus massages the shoulders by disposing the pair of massaging members in the contacting position.

A massager in another aspect of the present invention comprises a shoulder massaging apparatus including a pair of massaging members and a first moving device for moving the pair of members forwardly and backwardly of a user between a contacting position in which the pair of members contact with shoulders of the user and a retreated position in which the pair of massaging members are separated from the shoulders, to massage the shoulders by disposing the pair of massaging members in the contacting position, a neck massaging apparatus including a second moving device for moving the pair of between a contacting position in which the pair of members contact with a neck of the user and a retreated position in which the pair of massaging members are separated from the neck, to massage the neck by disposing the pair of massaging members in the contacting position, and a controlling apparatus for controlling operations of the shoulder massaging apparatus and the neck massaging apparatus.

The controlling apparatus is capable of controlling independent operation, before and after operation and simultaneous operation of the shoulder massaging apparatus and the neck massaging apparatus, respectively.

### BRIEF DESCRIPTION DRAWINGS

FIG. 1 is a schematic perspective view showing an embodiment in which a massager according to the present invention is applied to a mat body.

FIG. 2 is a partially exploded perspective view of the massager shown in FIG. 1.

FIG. 3 is an enlarged perspective view of the massager shown in FIGS. 1 and 2.

FIG. 4 is an explanatory view of an operation of the massager.

FIG. 5 is an explanatory view of an operation of the massager.

FIG. 6 is a sectional view taken along A-A line in FIG. 4.

FIG. 7 is a partially enlarged explanatory of a remote control shown in FIG. 1.

FIG. 8 is a controlling circuit view of the massager shown in FIG. 1.

FIG. 9 is a perspective view showing an embodiment in which the massager according to the present invention is applied to a chair.

FIG. 10 is an explanatory view of waist part showing a state in which a skin of a backrest in FIG. 9 is removed.

### BEST MODE FOR CARRYING OUT THE INVENTION

Hereinafter, the best mode for carrying out the present invention will be explained in detail with reference to the accompanying drawings.

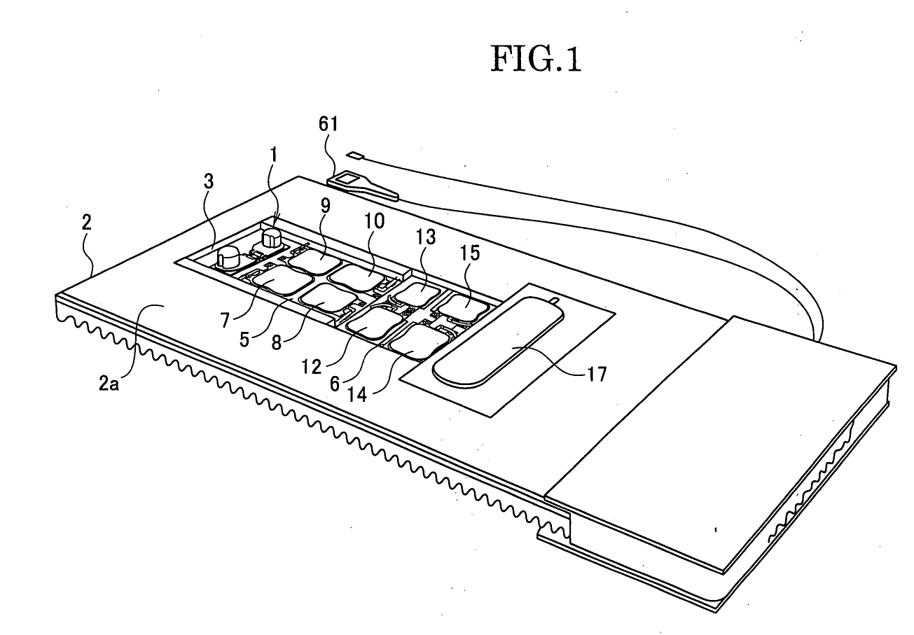

An embodiment in which a massager 1 according to the present invention is installed in a mat body 2 is shown in FIG. 1. The mat body 2 is made of a soft material such as urethane foam or the like. Actually, because the mat body 2 is covered by means of a cloth cover, which is not shown, an upper surface of the cloth cover is practically in a contacting surface with human's body, but the upper surface 2a of the mat body 2 becomes substantially a surface for supporting the body of a user.

The mat body 2 is formed with a concave portion 3 provided corresponding to an area in which the neck, shoulders, back, waist and so on of the user are disposed. A massager 1 for the neck and the shoulders, which will be explained hereinafter, is disposed on an area corresponding to the neck and the shoulders in the concave portion 3, a hard cardboard 5 of plastic is disposed as an airbag supporting plate in an area corresponding to the back, in the concave portion 3, and a cardboard 6 made of plastic is disposed as an airbag supporting plate in an area corresponding to the waist in the concave portion 3.

The cardboards 5 and 6 are disposed adjacently on the mat body 2 longitudinally of the mat body and disposed with a slight space with respect to each other. Consequently, the mat body 2 is adapted to be capable of folding between the cardboards 5 and 6. The cardboards 5 and 6 are formed by extrusion of synthetic resin such as polypropylene or the like. Meanwhile, a synthetic resin plate which is not easily bent, other than the polypropylene, or a plate-shaped member which is not easily bent, such as the other wood or metal, for example, an aluminum alloy or the other metal, or the like may be used for the cardboards 5 and 6.

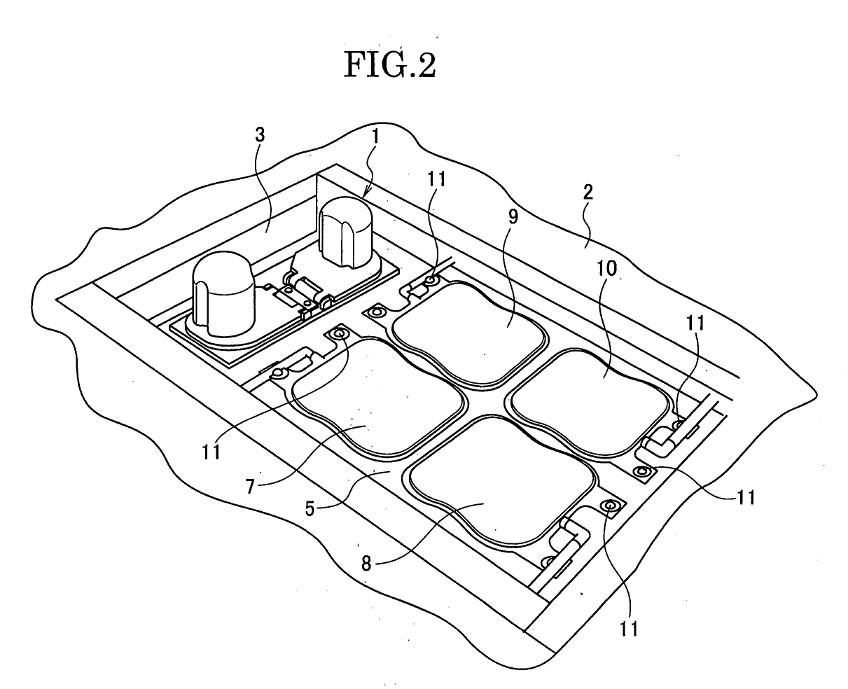

Airbags 7, 8 and 9, 10 are disposed on right and left portions of the cardboard 5, respectively, as shown in FIGS. 1 and 2. For example, one side of each of the airbags 7, 8, 9 and 10 is fixed to the cardboard 5 by bolts 11 or the like. The airbags 7 and 9 are disposed beside the massager 1 to massage a part of the back adjacent the shoulders, and the air bags 8 and 10 are disposed beside the cardboard 6 to massage a part of the back adjacent the waist.

Airbags 12, 13 and 14, 15 are disposed on the cardboard 6, as shown in FIG. 1. The airbags 12 and 13 are disposed on right and left portions of the cardboard 6 beside the cardboard 5, respectively to massage a part of the waist adjacent the back, and the air bags 14 and 15 are disposed on right and left portions of the cardboard 6 opposite to the cardboard 5, respectively to massage a part of the waist adjacent the hip.

In this way, by attaching the airbags 7 to 10 on the hard cardboard 5, the airbags 7 to 10 are prevented from sinking down when they are inflated.

Disposed on a central portion of the mat body 2 is also an airbag 17 for femoral region, which is disposed adjacent the cardboard 6 and extending rightward and leftward, as shown in FIG. 1. In addition, the airbags 12 to 15 are prevented from sinking down by attaching the airbags 12 to 15 on the hard cardboard 6 as described above, when the airbags 12 to 15 are inflated.

The massager 1 comprises a shoulder massaging apparatus 20 for massaging the shoulders of the user, a neck massaging apparatus 40 for massaging the neck of the user and a controlling apparatus 60 for controlling the shoulder massaging apparatus 20 and the neck massaging apparatus 40.

The shoulder massaging apparatus 20 includes a pair of massaging members 21 and a moving device or first moving device 22 for moving the pair of massaging members 21 toward the shoulders.

The neck massaging apparatus 40 includes the pair of massaging members 21 and a second moving device 41 for moving the pair of massaging members 21 toward the neck.

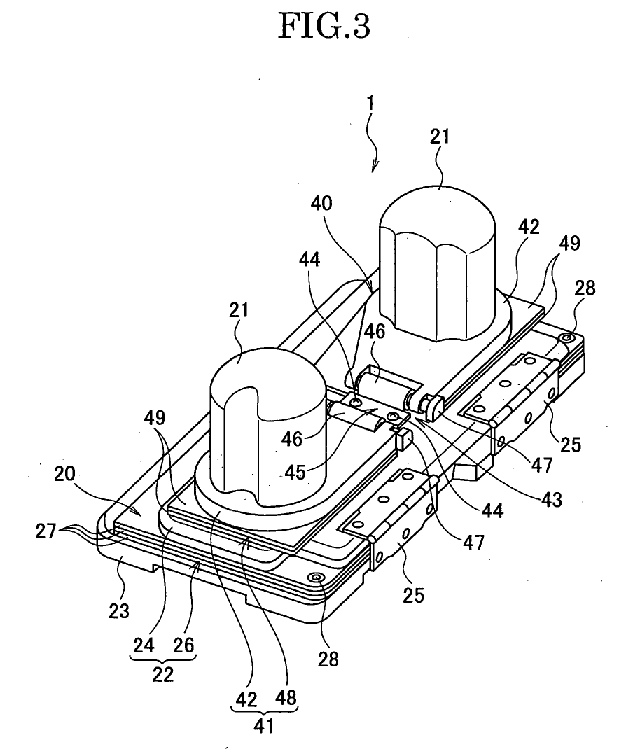

The first moving device 22 has a rectangular first supporting plate 24 disposed on a basic plate 23, which is rectangular as viewed from plane and fixed to the mat body 2, in the embodiment. The second moving device 41 has a pair of second supporting plates 42 disposed on the first supporting plate 24 (see FIG. 3). The massaging members 21 have cylindrical shapes, for example, as shown in FIG. 3, and are fixed to the pair of second supporting plates 42, respectively. A distance or space between the massaging members is adequately set so that the neck of the user is disposed between the massaging members when the massage is carried out. Moreover, the distance between the massaging members is adjustable, as described hereinafter.

One side of the first supporting plate 24 is rotatably attached to one side of the basic plate 23 by, for example, two hinges 25, and the pair of second supporting plates 42 are rotatably attached to the first supporting plate 24 through a hinge mechanism 43.

The hinge mechanism 43 has a bracket 45 fixed to the first supporting plate 24 by pins 44, cylindrical bodies 46 provided integrally on both sides of the bracket 45 and pivotal shafts 47 held rotatably in the cylindrical bodies 46 and held in the second supporting plates 42.

Here, it should be noted that the shoulder massaging apparatus 20 and the neck massaging apparatus 40 are disposed at the back of the user, the pair of massaging members 21 are disposed in the vicinity of right and left portions of the neck of the user, and thus the first supporting plate 24 is attached to the basic plate through the hinges 25 so that the massaging members 21 move forwardly and backwardly of the user between a contacting position for contacting with the shoulders and a retreated position spaced apart from the shoulders, and the pair of second supporting plates 42 are attached to the first supporting plate 24 through the hinge mechanism 43 so that the massaging members 21 move rightward and leftward of the user between a contacting position for contacting with the neck and a retreated position spaced apart from the neck

Consequently, an axis of each hinge 25, which is a rotational axis for the first supporting plate 24, extends rightward and leftward of the user, and a rotational axis for the second supporting plates, that is to say, axes of the cylindrical bodies 46 and the pivotal shafts 47 are disposed perpendicularly to the rotational axes of the hinges 25.

The first moving device 22 has a first driving mechanism 26 to move the massaging members 21 between the contacting position with the shoulders and the retreated position from the shoulders, and the second moving device 41 has a second driving mechanism 48 to move the massaging members 21 between the contacting position with the neck and retreated position from the neck.

The first driving mechanism 26 has a plurality of first airbags 27 disposed between the basic plate 23 and the first supporting plate 24, for example, and the second driving mechanism 48 has a plurality of second airbags 49 disposed between the first supporting plate 24 and the second supporting plates, respectively. The plurality of first airbags 27 are disposed to pile to each other and fixed to the basic plate 23 by means of screws 28. The plurality of second airbags 49 are also piled to each other and one end of each thereof is held and fixed between the bracket 45 and the first supporting plate 24.

An air supplying and exhausting mechanism 50 is provided to supply air to and exhaust air from the first and second airbags 27 and 49, the airbags 7 to 10, 12 to 16 and 17 disposed on the mat body 2. The air supplying and exhausting mechanism will be explained.

Meanwhile, the second supporting plates 42 are biased toward the first supporting plate 24 by a biasing mechanism such as a spring or rubber, which is not shown, the first supporting plate 24 is biased toward the basic plate 23 by a biasing mechanism such as a spring, rubber or the like. In addition, because the first airbags 27 are disposed between the basic plate 23 and the first supporting plate 24, as described above, they are forcibly deflated by means of a biasing force of the biasing mechanism at the time of exhausting air. Furthermore, because the second airbags 49 are disposed between the first supporting plate 24 and the second supporting plates 42, respectively, they are forcibly deflated by means of a biasing force of the biasing mechanism at the time of exhausting air. Thereby, exhaustion of air from the first and second airbags 27 and 49 can be carried out rapidly and smoothly.

In addition, although the first and second driving mechanisms 26 and 48 are structured by the airbags in the above embodiment, they are not limited to the airbags. For example, an air cylinder, motor and link mechanism, gear mechanism, motor and cam mechanism or the like may be used as the first and second driving mechanisms.

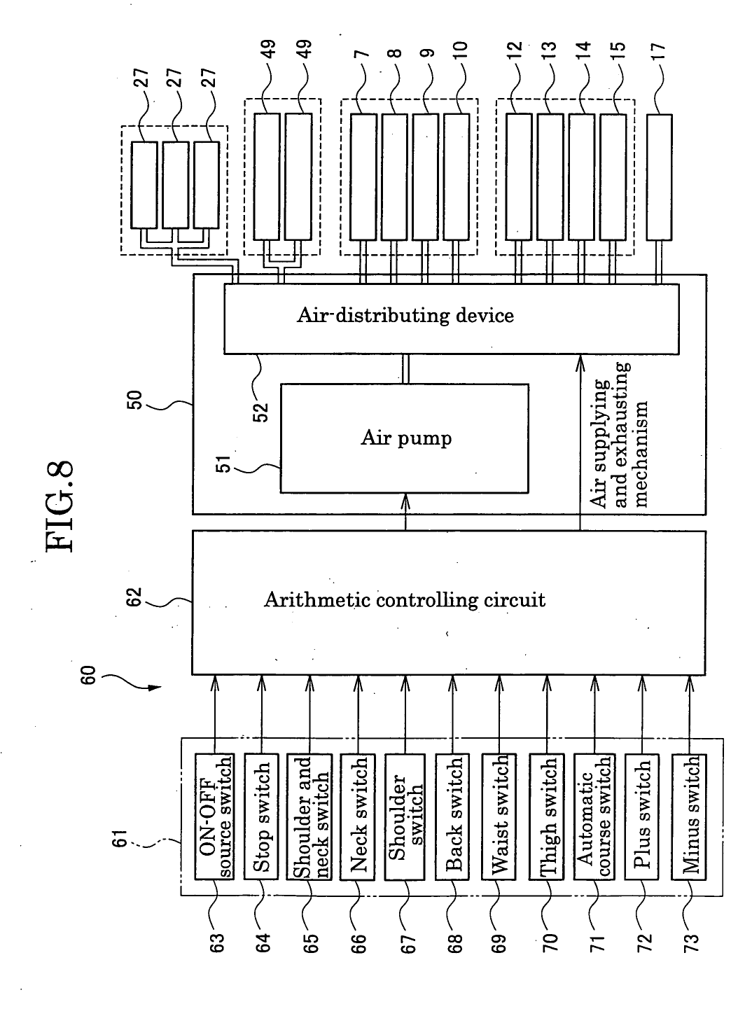

The controlling apparatus 60 has a remote control 61 as shown in FIGS. 1, 7 and 8, and an arithmetic controlling circuit 62 (FIG. 8) in which an operating signal from the remote control 61 is inputted. The arithmetic controlling circuit 62 controls an operation of the air supplying and exhausting mechanism 50 to control air supplied to and exhausted from the airbags 7 to 10, 12 to 15, and 17, and the first and second airbags 27 and 49.

The air supplying and exhausting mechanism 50 has an air pump 51, which is an air-supplying source and an air-distributing device 52 connected with an air outlet (not shown) of the air pump 51. The air-distributing device 52 causes the air outlet of the air pump 51 to communicate selectively with either of the airbags 7 to 10, 12 to 15, 17, 27 and 49, to allow air from the air pump 51 to supply to either of the airbags 7 to 10, 12 to 15, 17, 27 and 49. The air-distributing device 52 also communicate the airbags 7 to 10, 12 to 15, 17, 27 and 49 with atmosphere to allow air from the airbags 7 to 10, 12 to 15, 17, 27 and 49 to exhaust to the atmosphere.

A well-known rotary valve, electromagnetic valve or the like may be used as the air-distributing device 52, therefore its detailed description is omitted. Meanwhile, the air pump 51 and the air-distributing device 52 are controlled by the arithmetic controlling circuit 62.

Here, it is important that the controlling apparatus 60 is capable of controlling independent operation, before and after operation and simultaneous operation of the shoulder massaging apparatus 20 and the neck massaging apparatus 40, respectively.

Moreover, the independent operation means that each of the shoulder massaging apparatus 20 and the neck massaging apparatus 40 is driven independently. The before and after operation means that either one of the shoulder massaging apparatus 20 and the neck massaging apparatus 40 is first driven, and then the other is driven. The simultaneous operation means that the shoulder massaging apparatus 20 and the neck massaging apparatus 40 are driven at the same time.

Furthermore, it should be noted that the independent, before and after and simultaneous operations can be selectively executed, respectively.

The controlling apparatus 60 controls the first driving mechanism 26 so that a rate at which the massaging members 21 separate from the shoulders is later than a rate at which the massaging members approach to the shoulders, and controls the second driving mechanism 48 so that a rate at which the massaging members 21 separate from the neck is later than a rate at which the massaging members approach to the neck.

Moreover, the controlling apparatus 60, after it drives the second driving mechanism 48 to sandwich the neck by the massaging members 21, in this state, are controllable the first driving mechanism 26 so that the pair of messaging members approach to the shoulders of the user, and after this state is held a certain time, controllable the first and second driving mechanisms 26 and 48 so that the massaging members 21 separate from the shoulders and the neck.

Furthermore, the controlling apparatus 60 are controllable the first and second driving mechanisms 26 and 48 so that the massaging members 21 separate gradually from the shoulders and the neck, taking a longer time than a time by which the massaging members 21 direct or approach to the shoulders and the neck

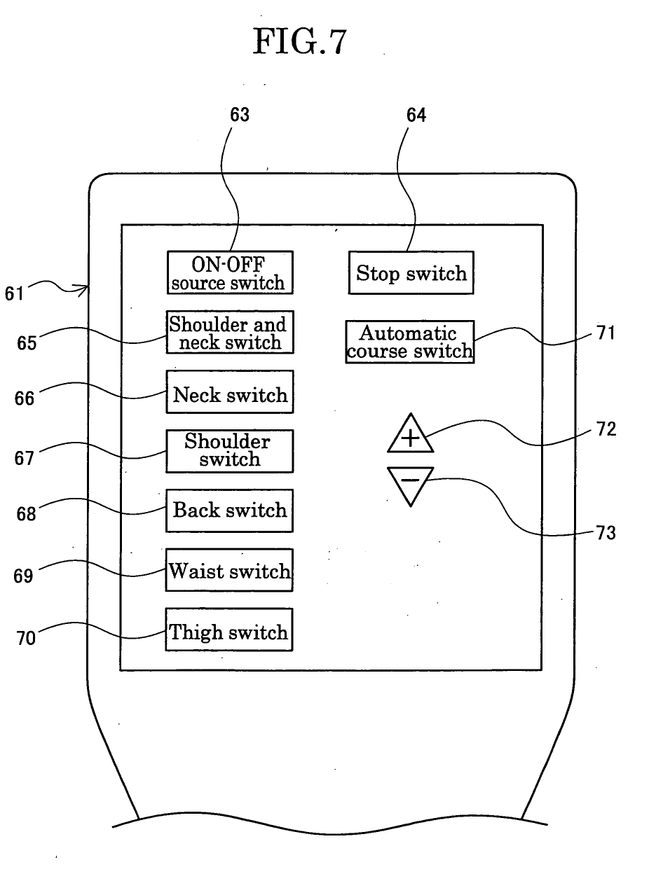

The remote control 61 includes an ON and OFF-source switch 63, a stop switch 64, a shoulder and neck switch 65, a neck switch 66, a shoulder switch 67, a back switch 68, a waist switch 69, a thigh switch 70, an automatic course switch 71, a space-adjusting plus switch 72, a space-adjusting minus switch 73 and so on, as shown in FIG. 7. Operational signals (ON-signals) from the switches 63 are inputted into the arithmetic controlling circuit 62.

Subsequently, a massaging control according to the arithmetic controlling circuit 62 in the massager 1 structured as described above will be explained.

When the massager 1 is used, the user lies face up on the mat body 2 so that a portion of the neck is positioned between the massaging members 21, the back is positioned on the airbags 7 to 10, the waist is positioned on the airbags 12 to 15 and the thighs are positioned on the airbag 17, and the user operates the remote control 61.

Then, when the source switch 63 of the remote control 61 is turned on, the arithmetic controlling circuit 62 stands-by for controlling an operation. In the state, the arithmetic controlling circuit 62 operates the air pump 51 and initiates an operational control of the air-distributing device 52, when the arithmetic controlling circuit 62 operates any of the switches 65 to 73.

(Back)

The arithmetic controlling circuit 62 also controls, when the back switch 68 is turned on, the operation of the air-distributing device 52 to inflate or deflate the airbags 7 to 10 in a predetermined sequence so that the back of the user is massaged by the airbags 7 to 10.

In addition, even if a pressure at the time that the airbags 7 to 10 are inflated is applied to the cardboard 5, because the airbags 7 to 10 are attached on the hard cardboard 5, the airbags 7 to 10 are prevented from sinking down when they are inflated.

(Waist)

Moreover, the arithmetic controlling circuit 62 controls, when the waist switch 69 is turned on, the operation of the air-distributing device 52 to inflate or deflate the airbags 12 to 15 in a predetermined sequence so that the waist of the user is massaged by the airbags 12 to 15.

In addition, even if a pressure at the time that the airbags 12 to 15 are inflated is applied to the cardboard 6, because the airbags 12 to 15 are attached on the hard cardboard 6, the airbags 12 to 15 are prevented from sinking down when they are inflated.

(Thighs)

Moreover, the arithmetic controlling circuit 62 controls, when the thigh switch 70 is turned on, the operation of the air-distributing device 52 to inflate or deflate the airbag 17 so that the thighs of the user are massaged by the airbag 17.

(Neck-Shoulders)

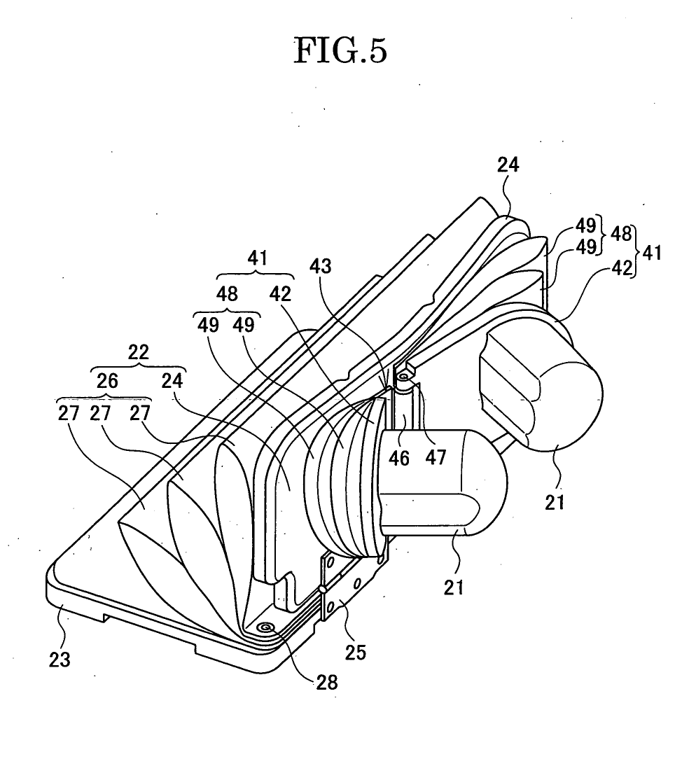

Furthermore, the arithmetic controlling circuit 62 controls, when the neck and shoulder switches 65 is turned on, the operation of the air-distributing device 52 of the air supplying and exhausting mechanism 50 to supply air to the plurality of first airbags 27, thus to inflate the airbags 27. By inflation of the first airbags 27, the first supporting plate 24 is rotated toward the shoulders of the user about the hinges 25, and the second supporting plates 42 attached to the first supporting plate 24 are also rotated toward the shoulders of the user, as shown in FIG. 5. Consequently, the massaging members 21, which are integral with the second supporting plates 42 are rotated toward the shoulders of the user.

At that time, the arithmetic controlling circuit 62 controls the operation of the air-distributing device 52 of the air supplying and exhausting mechanism 50 to supply air to the plurality of second airbags 49, thus to inflate these airbags 49. By inflation of the second airbags 49, the pair of second supporting plates 42 are rotated toward the neck of the user about the hinge mechanism 43 in a direction where free ends of the second supporting plates approach to each other, as a result, the massaging members 21 are rotated toward the neck and the shoulders of the user. Consequently, the massaging members 21, which are integral with the second supporting plates 42 are rotated toward the shoulders of the user.

With such operation, the massaging members 21 are rotated toward the neck simultaneously with the rotation toward the shoulders of the user. Accordingly, the massaging members 21 press the vicinity of a base of the neck while pressing so as to hold the vicinity of the base of the neck from right and left sides of the neck

Thereafter, the arithmetic controlling circuit 62 controls the operation of the air-distributing device 52 to exhaust air from the plurality of first and second airbags 27 and 49 to the atmosphere, thus to cause the airbags 27 and 49 to deflate. Thereby, the first and second supporting plates 24 and 42, and the massaging members 21 and so on are operated oppositely to the above and returned to original positions. By repeating the inflating and deflating operations of the airbags 27 and 49, a portion of the base of the neck of the user and portions of the shoulders can be massaged. Therefore, particularly, the portion of the base of the neck of the user can be massaged by means of the massaging members 21, similarly as a finger pressure operation, which is performed by a person.

(Neck)

The arithmetic controlling circuit 62 controls, when the neck switch 66 is turned on, the operation of the air-distributing device 52 of the air supplying and exhausting mechanism 50 to supply air to the plurality of second airbags 49, accordingly, these airbags 49 are inflated. By inflation of the second airbags 49, the pair of second supporting plates 42 are rotated toward the neck of the user about the hinge mechanism 43 in a direction where free ends of the second supporting plates approach to each other, as a result, the massaging members 21 are rotated toward the neck of the user.

With such operation, the massaging members 21 press the neck of the user so as to hold the neck from right and left sides of the neck. Accordingly, right and left portions of the neck of the user can be massaged by means of the massaging members 21.

Thereafter, the arithmetic controlling circuit 62 controls the operation of the air-distributing device 52 to exhaust air from the plurality of second airbags 49 to the atmosphere, thus to cause the airbags 49 to deflate. Thereby, the second supporting plates 42, and the massaging members 21 and so on are operated oppositely to the above and returned to the original positions. The right and left portions of the neck of the user can be massaged by repetition of the inflating and deflating operations of the airbags 49.

(Shoulders)

The arithmetic controlling circuit 62 controls, when the shoulder switch 67 is turned on, the operation of the air-distributing device 52 of the air supplying and exhausting mechanism 50 to supply air to the plurality of first airbags 27, thus to inflate these airbags 27. By inflation of the first airbags 27, the first supporting plate 24 is rotated toward the shoulders of the user about the hinges 25, and the second supporting plates 42 attached to the first plate 24 are rotated toward the shoulders of the user. As a result, the massaging members 21 are also rotated toward the shoulders of the user together with the second supporting plates 42 to cause the massaging members 21 to contact with the shoulders of the user. In this sate, the shoulders can be massaged by repetition of the supply of air to and the exhaust of air from the first airbags 27, in other words, inflation and deflation of the airbags.

Thereafter, the arithmetic controlling circuit 62 controls the operation of the air-distributing device 52 to exhaust air from the plurality of first airbags 27 to the atmosphere, thus to cause the airbags 27 to deflate. Thereby, the first and second supporting plates 24 and 42, and the massaging members 21 and so on are operated oppositely to the above and returned to the original positions.

By operating the plus switch 72 and the minus switch 73 during the massage of the shoulders, a space between leading ends of the massaging members 21 is adjusted so that a massaging part of the shoulders can be changed.

That is to say, the arithmetic controlling circuit 62 controls, when the minus switch 73 is operated during massaging the shoulders, the operation of the air-distributing device 52 of the air supplying and exhausting mechanism 50 to supply air to the plurality of second airbags 49 by a predetermined amount, thus to inflate these airbags 49 by a predetermined amount. By inflation of the second airbags 49, the second supporting plate 42 is rotated by a predetermined amount toward the neck of the user about the hinge mechanism 43 in a direction where the free ends of the second supporting plates 42 approach to each other, and the space of the massaging members 21 narrows by a predetermined amount. In this way, the space of the massaging members 21 narrows gradually every press of the minus switch 73 by a predetermined amount.

The arithmetic controlling circuit 62 controls, when the plus switch 72 is turned on during massaging the shoulders in the state that the plurality of second airbags 49 are inflated, the operation of the air-distributing device 52 of the air supplying and exhausting mechanism 50 to exhaust air from the plurality of second airbags 49 to the atmosphere by a predetermined amount, thus to deflate these airbags 49 by a predetermined amount. By deflation of the second airbags 49, the second supporting plates 42 are rotated by a predetermined amount in the opposite direction to the neck of the user about the hinge mechanism 43 or a direction where free ends of the second supporting plates separate from each other. As a result, the space between the massaging members 21 widens gradually by a predetermined amount every pressing the plus switch 72.

Meanwhile, the space between the massaging members 21 narrows continuously by supplying continuously air to the plurality of second airbags 49 only during pressing the minus switch 73, on the other hand, the space between the massaging members 21 widens continuously by exhausting continuously air from the plurality of second airbags 49 only during pressing the plus switch 72. In this way, the space between the pair of massaging members can be adjusted.

It is also possible to set in such a manner as to narrow or widen automatically and gradually the space between the massaging members 21 without operating the plus switch 72, the minus switch 73 and so on.

This can be achieved by controlling the operation of the air pump 51 and the air-distributing device 52 by means of the arithmetic controlling circuit 62, supplying gradually air to the airbags 49 every a predetermined amount, or exhausting gradually air from the airbags 49 to the atmosphere.

According to the above-mentioned structure, because the basic portions of the neck of the user can be held by the pair of massaging members 21 by performing simultaneously the inflation and deflation of the first and second airbags 27 and 49, the basic portions of the user can be massaged similarly as a finger pressure operation performed by a person.

The controlling device 60 in the embodiment controls the operation of the air supplying and exhausting mechanism 50 to supply air to the second airbags 49 and is set so that the second airbags 49 inflate and deflate by a predetermined amount and the space between the pair of massaging members 21 are adjusted.

With such structure, if the shoulders of the user are massaged, massaging positions of the shoulders by the massaging members 21 can be adjusted adequately.

Meanwhile, although the above-mentioned embodiment shows an example in which the massager 1 is applied to the mat body 2, the embodiment is not limited necessarily to the example. For example, the massager may be applied to a pillow.

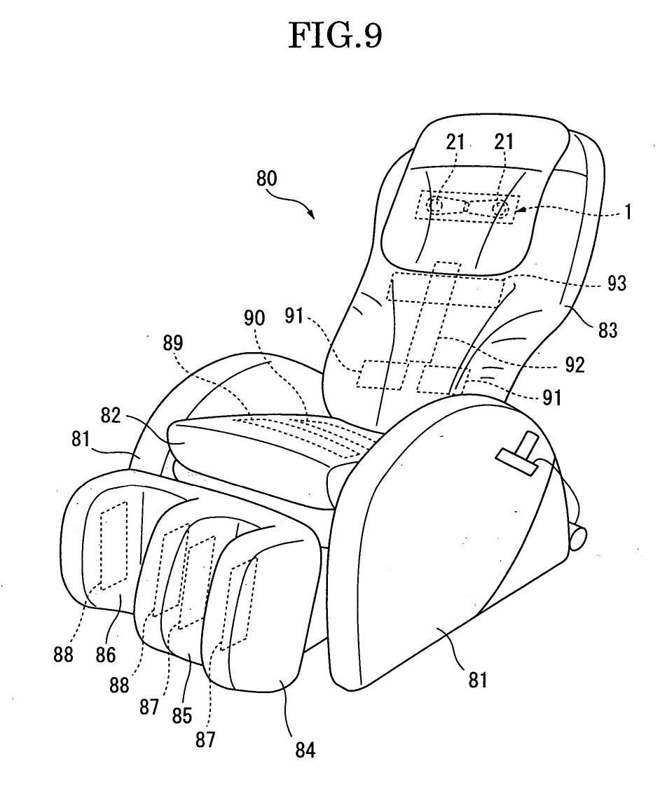

FIG. 9 illustrates an embodiment in which the massager 1 according to the present invention is applied to a chair as a massaging chair 80.

The massaging chair 80 in the embodiment has a seating part 82 supported by legs 81 and 81 and a backrest 83 attached to be capable of reclining on a back end of the seating part 82.

Moreover, a massaging stage 84 for massaging lower thighs or calves or is attached to a forward side of the seating part 82, and airbags 87, 87 and 88, 88 for massaging the lower thighs are attached adjacent to right and left leg-holding grooves 85 and 86, respectively, which are provided in the massaging stage 84. In addition, an airbag 89 for massaging upper thighs or thighs is provided on a forward side of an upper surface or human body-abutting surface of the seating part 82, and an airbag 90 for massaging the buttock or hips is attached on a backward side of the upper surface of the seating part 82.

Furthermore, airbags 91 and 91 for massaging the waist are attached on a lower portion of a front surface or human body-abutting surface of the backrest 83, and an airbag 92 for massaging muscles of the back of the user, extending upwardly and downwardly on a central portion between right and left sides of the front surface of the backrest 83. The airbag 92 is positioned at an upper position of the airbags 91 and 91 and disposed to correspond to the muscles of the back of the user. In addition, an airbag 93 for the back is disposed on the front surface of the backrest 83 to position at an upper end of the airbag 92 and to extend rightward and leftward.

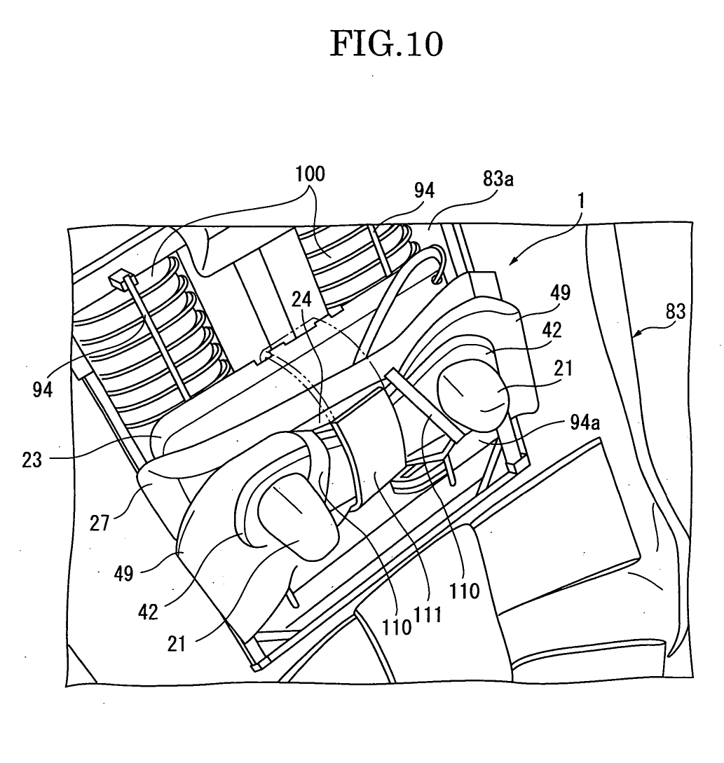

Moreover, a rectangular concave portion 83a is formed in an upper portion of the backrest 83 to correspond to the neck and the shoulders, as shown in FIG. 10. The massager 1 is disposed in the concave portion 83a to be capable of moving upwardly and downwardly of the backrest 83. More specifically, for example, the basic plate 23 of the massager 1 is fixed to two parallelly arranged airbags 100. Each of these airbags comprises two airbag bodies (not shown), which are arranged in series upwardly and downwardly, and an attaching plate (not shown) fixed between the airbag bodies. The basic plate 23 is fixed to the attaching plate. The airbag bodies are structured in such a manner that the lower airbag body is deflated when the upper airbag body is inflated, the upper airbag body is deflated when the lower airbag body is inflated, by such operation, the attaching plate is moved upwardly and downwardly. Accordingly, the massager 1 can be moved upwardly and downwardly by supplying air to and exhausting air from each of the up and down airbag bodies. Upwardly and downwardly extending guide rods 94 and 94 are disposed on right and left areas of the concave portion 83a to protect the airbag 100. The guide rods 94 and 94 are fixed to a frame 94a of the backrest 83. Meanwhile, FIG. 10 illustrates the massager 1 in a state that a skin of the backrest 83 as shown in FIG. 9 is removed.

The massaging chair 80 includes a controlling device similar to the aforementioned controlling device 60. That is to say, it has an air supplying and exhausting mechanism with which the airbag bodies and the airbags 87 to 93 are connected and similar to the air supplying and exhausting mechanism 50, a remote control similar to the remote control 61, an arithmetic controlling circuit similar to the arithmetic controlling circuit 62 and so on. Supplying air to and exhausting air from the airbags are controlled by means of the controlling device, similarly to the above.

As described above, because the massager 1 can be moved upwardly and downwardly along the backrest, not only the neck and the shoulders, but also the back and so on can be massaged.

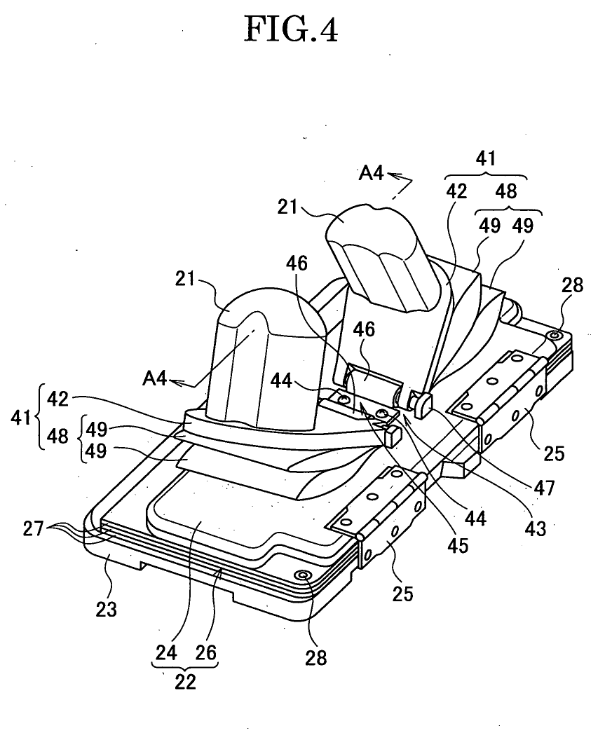

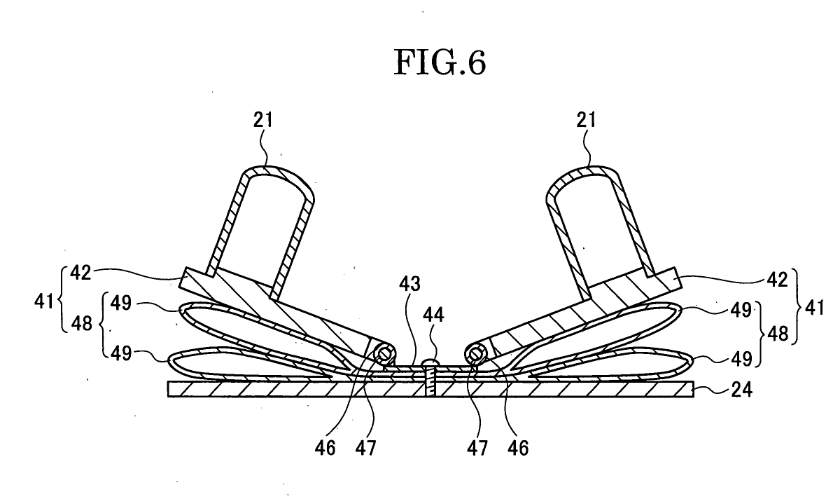

The structure of the massager 1 is the same as in the first embodiment shown in FIGS. 3 to 6. In addition, the second supporting plates 42 are biased toward the first supporting plate 24 by a rubber 110 as a biasing mechanism. The first supporting plate 24 is biased toward the basic plate 23 by a rubber 111 as a biasing mechanism. Moreover, because the first airbags 27 of the massager 1 are disposed between the basic plate 23 and the first supporting plate 24, they are deflated forcibly by means of a biasing force of the rubber 111, when air is exhausted from the airbags. Furthermore, because the second airbags 49 of the massager 1 are disposed between the first and second supporting plates 24 and 42, they are deflated forcibly by means of a biasing force of the rubber 110, when air is exhausted from the airbags. Thereby it is possible to supply air to and exhaust air from the airbags 27 and 49 rapidly and smoothly.

The plurality of first airbags and the plurality of second airbags are provided, but the present invention is not limited to the structure. For example, one first airbag and one second airbag may be provided.

According to the present invention, it is possible to contact the massaging members with the shoulders of the user without the user moving, as described above, and there is an advantageous effect that the portion of the base of the neck can be massaged similarly as the finger pressure operation performed by a person.

### INDUSTRIAL APPLICABILITY

In the above embodiments, although the massager according to the present invention is applied to the mat body or the chair, the present invention is not limited to the embodiments. In the massager according to the present invention, it is possible to install it in a seat or cushion and a compact mobile massager can be structured.

1. A massager comprising:
a shoulder massaging apparatus including;
a pair of massaging members, and
a moving device for moving the pair of massaging members forwardly and backwardly of a user between a contacting position in which the pair of massaging members contact with shoulders of the user and a retreated position in which the pair of massaging members are separated from the shoulders,
the shoulder massaging apparatus being configured to massage the shoulders by disposing the pair of massaging members in the contacting position.

2. A massager comprising
a shoulder massaging apparatus including a pair of massaging members and a first moving device for moving the pair of massaging members between a contacting position in which the pair of massaging members contact with shoulders of a user and a retreated position in which the pair of massaging members are separated from the shoulders to massage the shoulders by disposing the pair of massaging members in the contacting position;
a neck massaging apparatus including a second moving device for moving the pair of massaging members between a contacting position in which the pair of massaging members contact with the user's neck and a retreated position in which the pair of massaging members are separated from the neck to massage the neck by disposing the pair of massaging members in the contacting position; and
a controlling apparatus for controlling operations of the shoulder massaging apparatus and the neck massaging apparatus,
the controlling apparatus being capable of controlling independent operation, before and after operation and simultaneous operation of the shoulder massaging apparatus and the neck massaging apparatus, respectively.

3. The massager according to claim 2, wherein said first moving device has a first supporting plate disposed on a basic plate,
the second moving device has a pair of second supporting plates disposed on the first supporting plate,
each of the pair of massaging members is fixed to each of the second supporting plates,
the first supporting plate is attached rotatably at its one side to one side of the basic plate so that the massaging members approach to and separate from the shoulders of the user, and
the pair of second supporting plates having mutually opposite ends attached rotatably to the first supporting plate so that the second supporting plates approach to and separate from the neck of the user.

4. The massager according to claim 3, wherein the first moving device has a first driving mechanism for driving the first supporting plate, and
the second moving device has a second driving mechanism for driving the second supporting plate.

5. The massager according to claim 4, wherein the first and second driving mechanisms include airbags.

6. The massager according to claim 4, wherein the controlling apparatus controls the first driving mechanism so that a rate at which the massaging members separate from the shoulders is later than a rate at which the massaging members approach to the shoulders, and controls the second driving mechanism so that a rate at which the massaging members separate from the neck is later than a rate at which the massaging members approach to the neck.

7. The massager according to claim 2, further comprising an energizing mechanism for assisting the operation of the first moving device when the first moving device drives to separate the massaging members from the shoulders, and for assisting the operation of the second moving device when the second moving device drives to separate the massaging members from the neck.

8. The massager according to claim 2, wherein a space between the pair of massaging members is adjustable.

9. The massager according to claim 4, wherein the controlling apparatus, after it operates the first driving mechanism so that the massaging members approach to the shoulders of the user, in the state, controls the second driving mechanism to allow the pair of massaging members to approach to the neck of the user, and after the state is held a certain time, controls the first and second driving mechanisms so that the massaging members separate from the shoulders and the neck.

10. The massager according to claim 4, wherein the controlling apparatus, after it operates the second driving mechanism so that the massaging members hold the neck of the user, in the state, controls the first driving mechanism to allow the pair of massaging members to approach to the shoulders of the user, and after the state is held a certain time, controls the first and second driving mechanisms so that the massaging members separate from the shoulders and the neck.

11. The massager according to claim 2, wherein the controlling apparatus controls the first and second moving devices so that the massaging members separate gradually from the shoulders and the neck taking a longer time than a time in which the massaging members direct to the shoulders and the neck.

12. The massager according to claim 1, wherein it is provided in a mat body.

13. The massager according to claim 2, wherein it is provided in a mat body.

14. The massager according to claim 1, wherein it is provided in a backrest of a chair movably upwardly and downwardly.

15. The massager according to claim 2, wherein it is provided in a backrest of a chair movably upwardly and downwardly.
